(19) United States
(12) Patent Application Publication
(10) Pub. No.: US 2002/0103725 A1
(43) Pub. Date: Aug. 1, 2002

(54) Inventory and order management tool

(76) Inventors: Lisa S. Martin, Austin, TX (US); Tracy A. Masson, Austin, TX (US); Matthew S. Snyder, Austin, TX (US); Philip F. Mallory, Round Rock, TX (US)

Correspondence Address: Stephen A. Terrile, SKJERVEN MORRILL MacPHERSON LLP, Suite 700, 25 Metro Drive, San Jose, CA, 95110-1349, US

(21) Appl. No.: 09/773,102

(22) Filed: Jan. 31, 2001

(51) Int. Cl. G06F 17/60

(52) U.S. Cl. 705/28

(57) ABSTRACT

The disclosure teaches a process for ordering material, goods and services. Also disclosed are processes for assembling and manufacturing a computer system. A manufacturer orders material from a supplier. The material can be provided by the supplier from a supplier logistics center. The manufacturer owns the material after it is shipped by the supplier. The material is delivered by the supplier to a manufacturing or assembly facility. The material can be ordered when the manufacturer realizes a need for the material. The manufacturer realizes a need for the material after receiving orders for products requiring the material. The material can be ordered after the manufacturer considers the inventory on-hand at a supplier logistics center. The material can be ordered automatically by a system such as a computer program operating on a computer system. The order can specify the material be delivered in a specified period of time, for example one day.

### BACKGROUND OF THE INVENTION

1. Field of the Invention

The invention relates generally to managing orders for goods and services and more specifically to a tool for managing orders for goods and services.

2. Description of the Related Art

It is known that manufacturers assemble computers and other goods from components supplied by vendors and other suppliers. In some cases a supplier may be both a manufacturer and assembler. An extensive network of vendors, suppliers and assemblers has developed to meet the need of the electronics manufacturing industry.

It is known to develop a plan, specification or design from which to assemble a specific product. The plan, specification or design will identify the material required to assemble a completed product. This list of materials, including quantities, is known as a bill of materials (BOM). Vendors submit bids to provide components as specified in the bill of materials.

Manufactured products in general, and computer systems in particular are assembled from components obtained from numerous vendors. Vendors, assemblers and other manufacturers ship material to a manufacturer's facility for use in assembling a completed product. Shipping material to a manufacturer's facility creates problems in accurately determining when the material will be required. Shipping materials early creates problems with storage, security and handling. Shipping materials after they are required creates problems with shortages. Shortages delay a production schedule, increasing costs for manufacturers. These costs can result in higher prices paid by consumers. What is needed is a method to accurately request material requirements for a manufacturing facility. Ideally, the method will determine the material needed accurately enough to ensure that required materials are on-hand without requiring surplus materials on-hand.

### SUMMARY OF THE INVENTION

The disclosure teaches a method for ordering material from a supplier, including goods and services. The disclosure teaches a process for ordering material. Also disclosed are processes for assembling and manufacturing a computer system. A manufacturer orders material from a supplier. The material can be provided by the supplier from a supplier logistics center (also referred to as a “hub” or “supply logistic center”). In one embodiment the manufacturer owns (takes title to) the material when the material is shipped by the supplier.

The material can be ordered when the manufacturer realizes a need for the material. The manufacturer realizes a need for the material after receiving orders for products requiring the material. The material can be ordered after the manufacturer considers the inventory on-hand at a supplier logistics center. The material can be ordered automatically by a system such as a computer program operating on a computer system. The order can specify the material be delivered in a specified period of time, for example one day. But the period of time should not be taken to be limiting, the manufacturer can specify delivery in a much shorter period of time, for example 2 hours or even 1 hour.

Computer users and other consumers benefit from the method. The method reduces costs to manufacture or assemble a computer and facilitates make-to-order manufacturing of a computer system.

### BRIEF DESCRIPTION OF THE DRAWINGS

The present invention may be better understood, and its numerous objects, features, and advantages made apparent to those skilled in the art by referencing the accompanying drawings.

FIG. 1 shows a block diagram of a supply chain which includes an inventory and order management tool.

FIG. 2 shows a block diagram of the inventory and order management tool of FIG. 1.

FIG. 3 shows a block diagram of the data flow of the inventory and order management tool of FIG. 1.

FIG. 4 shows an example of a screen presentation of a user interface of the inventory and order management tool.

FIG. 5 shows an example of a screen presentation of a user interface of the inventory and order management tool.

FIG. 6 shows an example of a screen presentation of a user interface of the inventory and order management tool.

FIG. 7 shows an example of a screen presentation of a user interface of the inventory and order management tool.

FIG. 8 shows an example of a screen presentation of a user interface of the inventory and order management tool.

FIG. 9 shows a block diagram of a computer system suitable for implementing embodiments of the method.

FIG. 10 is a block diagram illustrating a network environment in which embodiments of the method may be practiced.

The use of the same reference symbols in different drawings indicates identical items unless otherwise noted.

### DETAILED DESCRIPTION

The following sets forth a detailed description of a mode for carrying out the invention. The description is intended to be illustrative of and should not be taken to be limiting. Features of the tool relate to various aspects of ordering material and manufacturing a product. A manufacturer analyses orders to determine material required to assemble products to fill the orders. The manufacturer's analysis also determines the quantity of each item required. (A computer system is an example of the product to be manufactured.) The manufacturer's analysis can develop a production plan for an assembly facility. After analyzing pending orders received from customers, the manufacturer places orders with the manufacturer's suppliers. Orders from the manufacturer to the manufacturer's suppliers can specify a time period within which the ordered material is to be delivered.

A feature of the tool provides that manufacturer does not take title to the material ordered until the material is shipped by the supplier. One embodiment teaches the manufacturer taking title (or ownership) of the material coincident to receipt of the material at the manufacturing facility. Another embodiment teaches specifying a time period for receipt of the material ordered. Thus taking ownership of the material can be dependent upon the material arriving at the manufacturer's facility at the time required, or within a specified time period. For example, taking ownership of the material in one embodiment can be dependent upon the material arriving at the manufacturing facility on the day ordered. In another embodiment, taking ownership of the material can depend on the material arriving at the manufacturing facility on the day ordered within two hours of a specified time. Thus, a manufacturer can take ownership and hence pay for material if it is received at the location and at the time required.

Another feature teaches that the manufacturer considers the quantity of material available from a supplier. In this feature the material can be available at the supplier logistics center (SLC), the supplier's factory or another location. When developing a production plan the manufacturer reviews a suppliers on-hand inventory. Considering a supplier's on-hand inventory allows a manufacturer to develop a more accurate manufacturing plan with less possibility of manufacturing interruptions due to unavailable material.

Another feature generates orders for materials. In an aspect of this feature the order is electronically transmitted to a supplier. The supplier determines the supplier's ability to provide the specified material before accepting, or confirming the order. According to this feature a supplier can confirm the quantity ordered or another quantity.

For example, a supplier may package a product in specific quantities, e.g., a supplier of disk drives may package the disk drives in boxes of 100. In this example, after receiving an order for 28 disk drives the supplier can confirm shipment of the greater quantity, in this case 100 hard drives. In this example, the supplier confirms shipment of the packaged quantity (100) instead of the quantity ordered (28) and ships the greater quantity. An embodiment of the feature is completely automated, requiring no direct human interaction to communicate an order to a vendor.

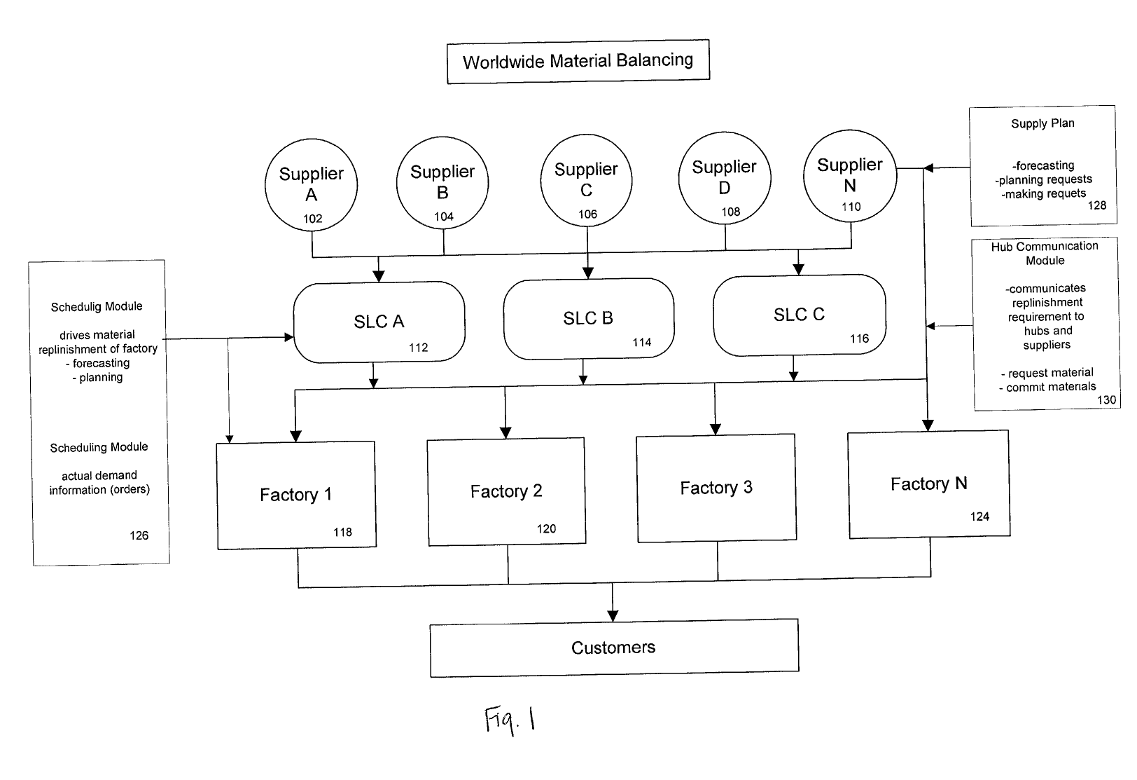

Referring to FIG. 1, five suppliers are depicted; Supplier A 102, Supplier B 104, Supplier C 106, Supplier D 108 and Supplier N 110. However, the present method is not limited to 5 suppliers. Use of the identifier “N” indicates that the method is applicable to a number of suppliers greater than five. A feature referred to as the Supply Plan (SP) provides information including forecasts and planning requests to the suppliers. An example of a software module with the features of the Supply Plan is the Material Replenishment Plan available from i2 Technologies, Inc. of Irving, Tex. From the information received from the SP, the suppliers provide material shipments to the three supplier's logistics centers shown as SLC A 112, SLC B 114 and SLC C 116. Again although three supplier's logistics centers are shown, the method is not limited to 3 centers. Supplier's logistics centers 112, 114 and 116 ship material to manufacturing facilities shown as Factory 118, Factory 120, Factory 122 and Factory 124. Factory 124 is further identified as “N” indicating that although 4 manufacturing facilities are depicted, the method is applicable to more than four manufacturing facilities.

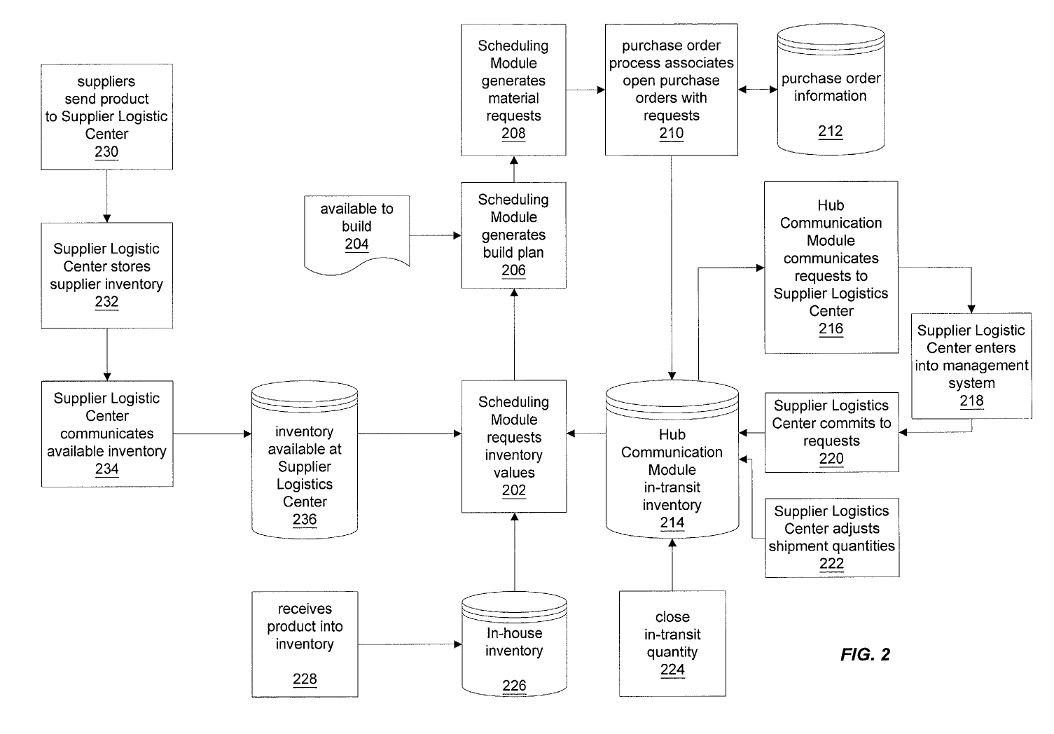

Referring to FIG. 2, the process may be described as a set of events. Each event may be described as a logical step. Event 202 requests inventory values. Event 206 generates a build plan based in information received from event 204. Event 204 provides information regarding customer orders. Event 208 generates material requests and passes the material requests to event 210. Event 210 associates requests for material received from event 208 with open purchase orders. Event 210 queries purchase orders from event 212 to assign to the material requests. Event 210 also determines which supplier will receive a request for materials. Event 212 is a system of record for the manufacturer's purchase orders and communicates those purchase orders to event 210. Event 214 stores the material request received from event 210 and communicates inventories which are in-transit from the supplier or supplier logistics centers.

Still referring to FIG. 2, Hub Communication Module (HCP) 216 shares requests with the supplier logistics center. An example of the Hub Communication Module is the Rhythm Collaboration Planner available from i2 Technologies, Inc. of Irving, Tex. For example, sharing requests can be done over a network such as the internet. However, this example should not be taken to be limiting. The information can also be shared over a corporate intranet, corporate extranet or even a virtual network. Warehouse management system 218 provides data from event 216 to suppliers or SLC. A supplier logistics center can create an order on behalf of a supplier. In this case, event 218 creates the order. Event 220 shares the inventory allocation performed in event 218 with the manufacturer's inventory system as shown in event 214. Event 222 shares changes to actual fulfillment quantity with the manufacturer's inventory system as shown in event 214. Event 224 confirms receipt of material ordered and adjusts in-transit quantities to reflect received material.

Still referring to FIG. 2, event 228 accepts inventory into the manufacturer's inventory system. Event 228 receives the material ordered. Event 226 is a database of manufacturer's owned inventory. Event 230 indicates the logical step of a supplier shipping material to a supplier logistics center. Event 232 indicates a supplier storing material in a supplier logistics center. Event 234 transmits current available inventory status to logical event 236 which is the manufacturer's data base of available material. Event 236 represents a database of supplier owned material which identifies material immediately available at the supplier logistics center. The material identified in event 236 represents material available for scheduling by the manufacturer.

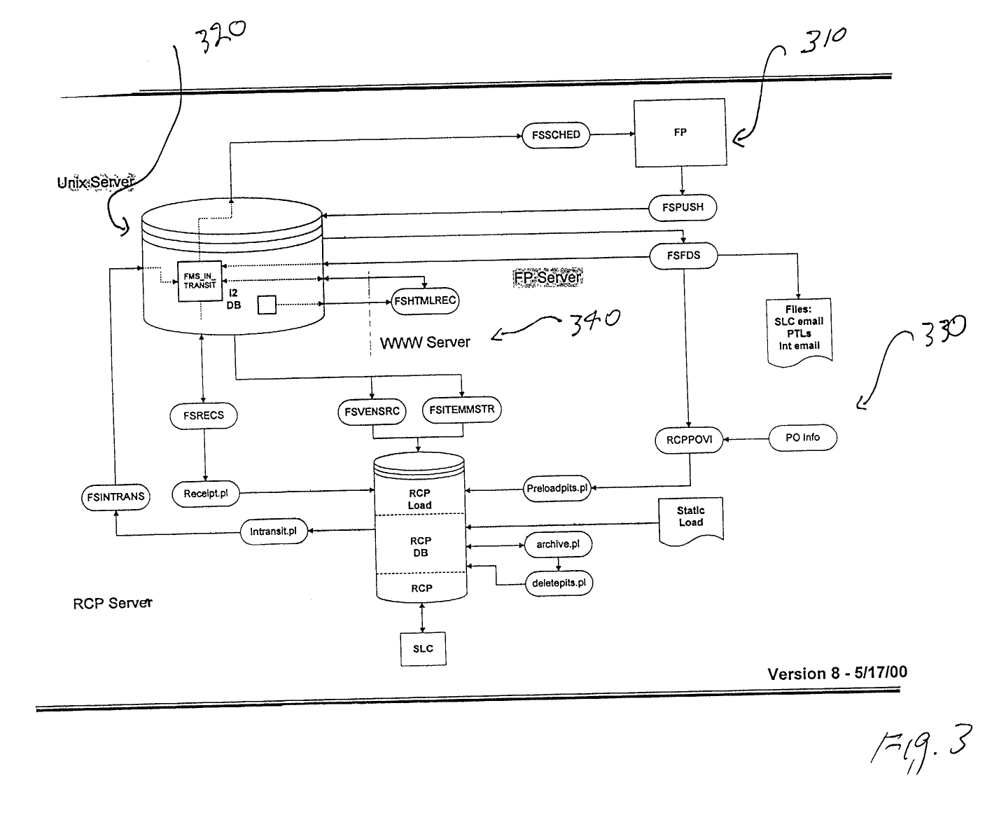

Referring to FIG. 3, Scheduling Module (SM) server 310 determines the factory build requirements. An example of a software module incorporating features of the Scheduling Module is Factory Planner, available from i2 Technologies, Inc. of Irving, Tex. Unix server 320 records the updates from the supplier of the expected receipt quantities. Hub Communication Module (HCM) server 330 provides a secure network based communication of the requirements determined by SM server 310. The world wide web (WWW) server 340 groups requests and determines when to send files from the Unix server.

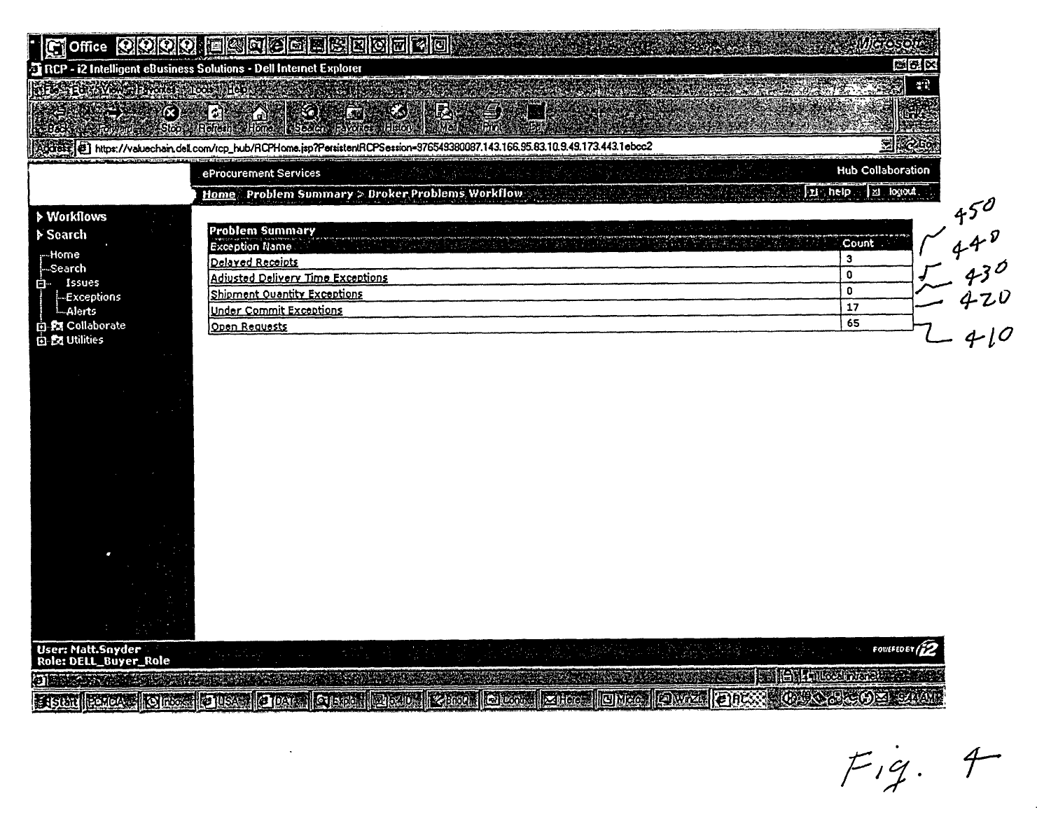

FIG. 4 depicts the primary user screen for the manufacturer and also for use by the operators of the supplier logistics center. FIG. 4 provides a summary of the exceptions to the planned flow of materials. For example, as shown on feature 410 of FIG. 4, there are 65 requests that have not been satisfied by a commitment from a SLC. Feature 420 allows a user to determine if an SLC commits to providing the requested material, but commits to providing a smaller quantity than requested by the manufacturing facility. Feature 430 allows a user to determine if an SLC has shipped less than the quantity requested and committed. FIG. 440 allows a user to determine if an SLC has adjusted the time the supplier has committed to providing the material at the manufacturer's facility. Feature 450 allows a user to determine if the manufacturer has not received the material which the SLC has previously committed to provide, in the expected time.

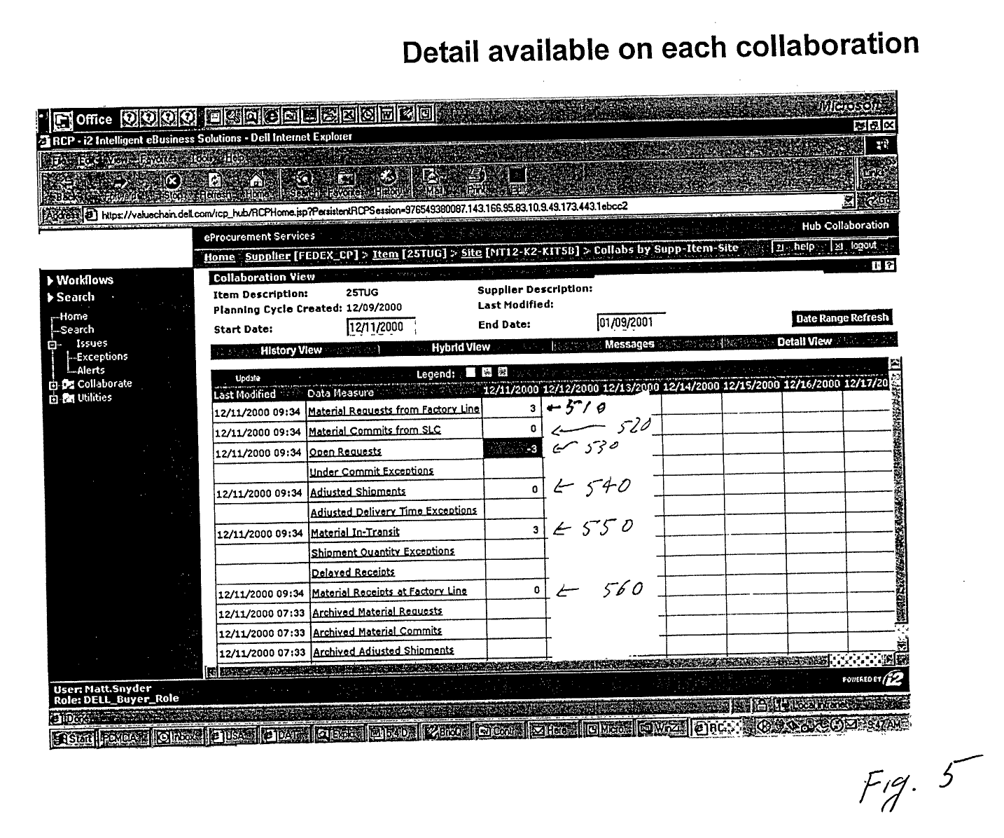

FIG. 5 shows data measures which reflect the supply of material from the SLC to the manufacturing facility. Feature 510 reflects quantity requested by a manufacturing facility. Feature 520 reflects the quantity of material allocated to the request by the manufacturing facility. Feature 530 reflects the quantity of material for which requests have been made but for which commitments have not been received from a supplier. Feature 540 reflects the quantity of supplier owned material provided to fill the request. If the supplier provides a quantity other than the quantity ordered, the actual quantity is reflected in Feature 540, not the quantity ordered. Feature 550 is the current quantity of supplier owned material committed to be shipped by the supplier logistics center to the manufacturing facility. Feature 550 is constantly updated to reflect information provided by the supplier logistic center. Feature 560 reflects materials received at the manufacturing facility.

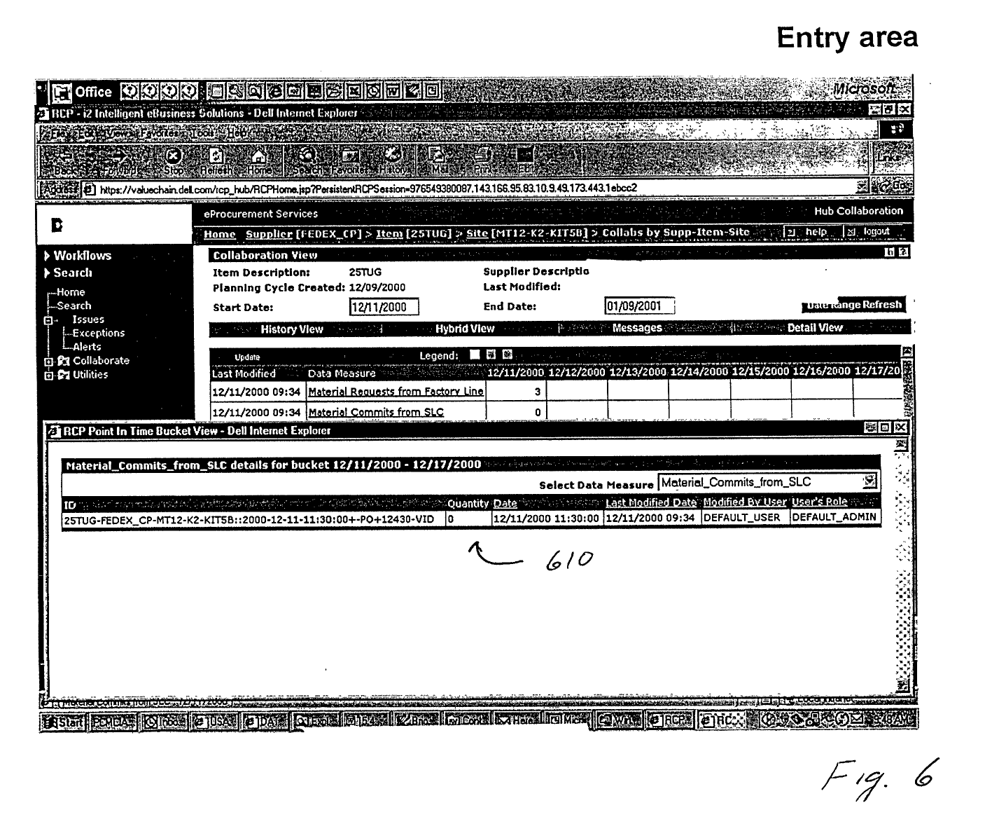

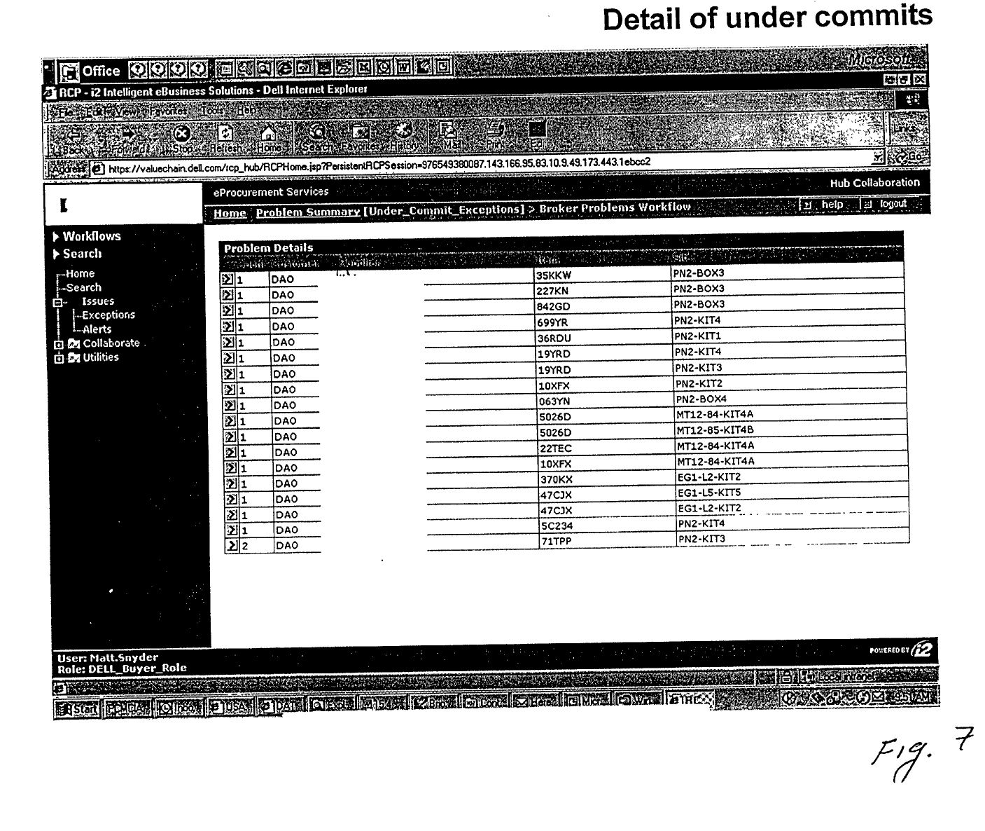

FIG. 6 is a plan view of a computer screen showing a user interface with a computer program executing the method. FIG. 6 shows a screen which allows users to enter specific data. For example, a supplier can enter quantity 610 to reflect the inventory allocation in their system. This is an example of the method which suppliers can use to share inventory allocation quantities and promised delivery date/time information. FIG. 7 is a plan view of a computer screen showing a user interface with a computer program executing the method. FIG. 7 shows a screen which displays only those requests for which the supplier has allocated less inventory than the manufacturer requested.

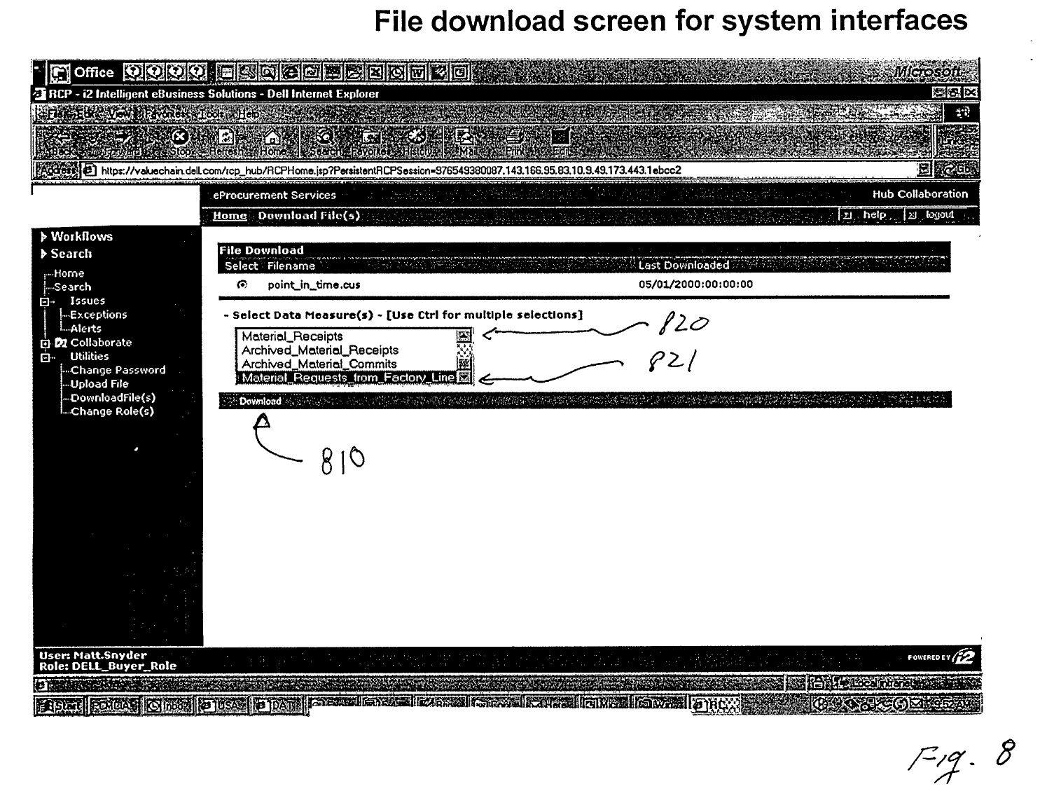

FIG. 8 is a plan view of a computer screen showing a user interface with a computer program executing the method. FIG. 8 shows a screen which allows a user to download summary files of particular data measures. For example, feature 810 allows a vendor to down load a file selected from drop down menu 820. For example, a file of all material requests received from a factory can be selected using feature 821 and downloaded by the supplier. For example, the supplier can download the material requests at a supplier logistics center.

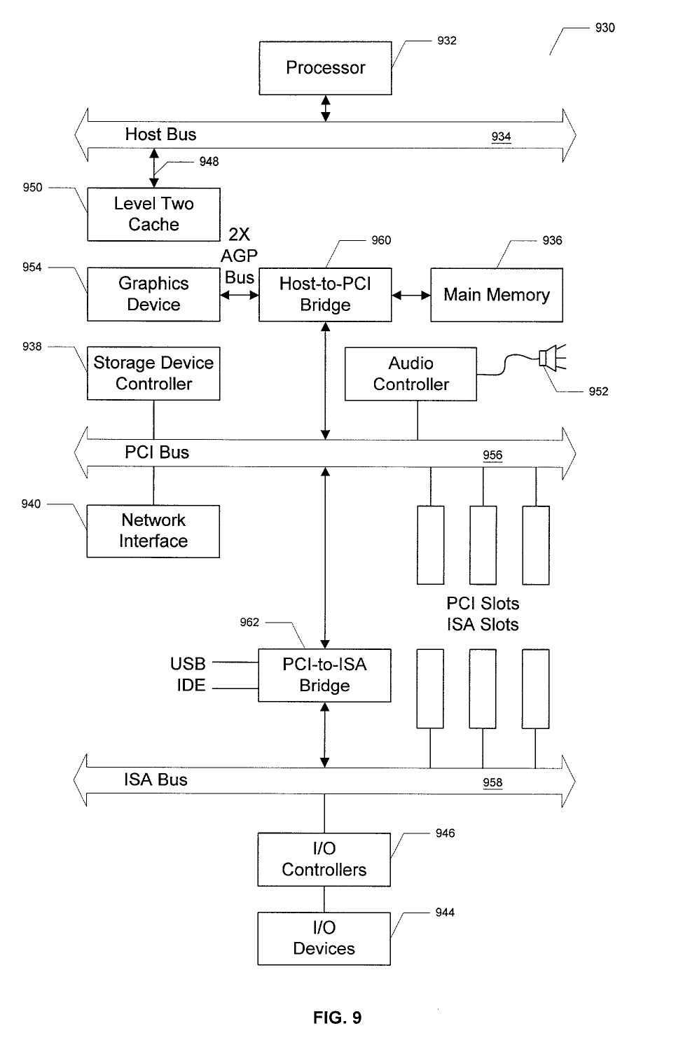

The present disclosure is applicable to any manufactured good. For example, a computer system as shown in FIG. 9 is used as an example of a manufactured product for which the method may be practiced. But the method is not limited to the computer system shown. Computer system 930 includes central processing unit (CPU) 932 connected by host bus 934 to various components including main memory 936, storage device controller 938, network interface 940, audio and video controllers 942, and input/output devices 944 connected via input/output (I/O) controllers 946. Those skilled in the art will appreciate that this system encompasses all types of computer systems including, for example, mainframes, minicomputers, workstations, servers, personal computers, Internet terminals, network appliances, notebooks, palm tops, personal digital assistants, and embedded systems.

Typically computer system 930 also includes cache memory 950 to facilitate quicker access between processor 932 and main memory 936. I/O peripheral devices often include speaker systems 952, graphics devices 954, and other I/O devices 944 such as display monitors, keyboards, mouse-type input devices, floppy and hard disk drives, DVD drives, CD-ROM drives, and printers. Many computer systems also include network capability, terminal devices, modems, televisions, sound devices, voice recognition devices, electronic pen devices, and mass storage devices such as tape drives. The number of devices available to add to personal computer systems continues to grow, however computer system 930 may include fewer components than shown in FIG. 9 and described herein. The peripheral devices usually communicate with processor 932 over one or more buses 934, 956, 958, with the buses communicating with each other through the use of one or more bridges 960, 962.

An Example Operating Environment

As discussed previously, features may communicate information electronically. For example referring briefly to FIG. 2, event 218 communicates electronically with suppliers as in event 220. Similarly, event 234 also communicates through a network with event 236. The method may communicate information electronically across a medium such as the internet but may also exchange information across any other operable medium. For example, the network specified can be any commercial communication network such as a corporate network (intranet), extension of an intranet to allow outside access (extranet) or private network such as a virtual private network. Therefore, use of the internet as an example is not limiting.

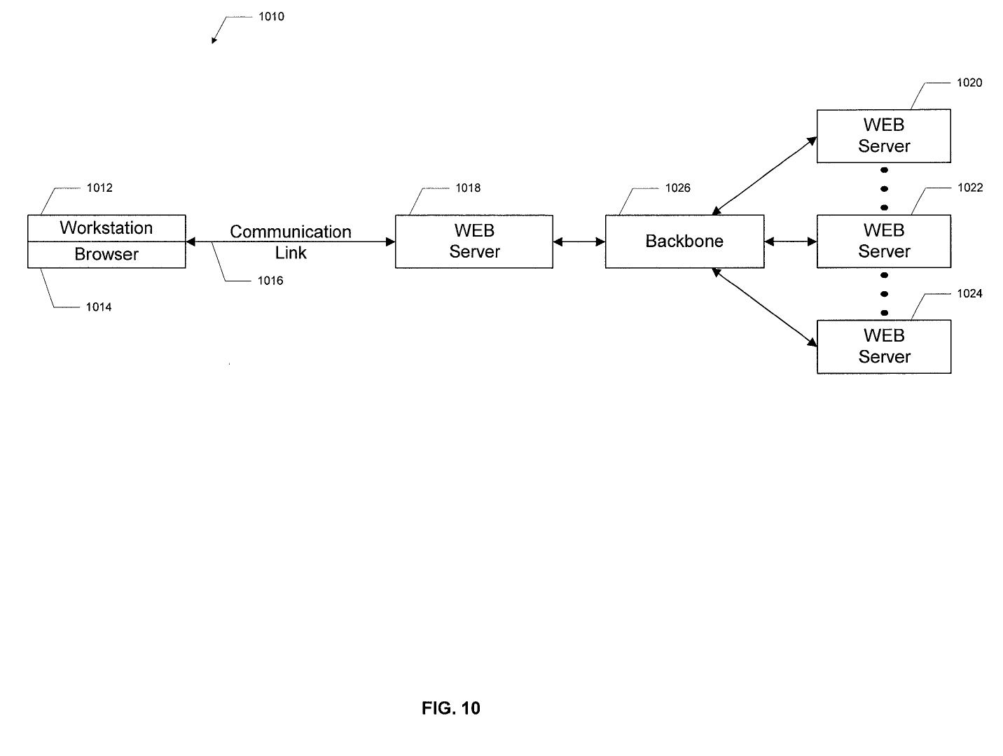

An example of a typical Internet connection is shown in FIG. 10. A user that wishes to access the Internet typically has a computer workstation, such as computer system 930 as shown in FIG. 9. Workstation 1012 executes an application program known as a web browser 1014. Workstation 1012 establishes a communication link 1016 with web server 1018 such as a dial-up wired connection with a modem, a direct link such as a T1 or ISDN line, a wireless connection through a cellular or satellite network. When the user enters a request for information by entering commands in web browser 1014, work station 1012 sends a request for information, such as a search for documents pertaining to a specified topic, or a specific web page to web server 1018. Each web server 1018, 1020, 1022, 1024 on the Internet has a known address which the user must supply to the web browser 1014 in order to connect to the appropriate web server 1018, 1020, 1022, or 1024. If the information is available on the user's web server 1018, a central link such as backbone 1026 allows web servers 1018, 1020, 1022, 1024 to communicate with one another to supply the requested information. Web server 918 services requests for the information and receives information from (or transmits information to) workstation 1012. In an embodiment a user may use a workstation, such as workstation 1012 to transmit information to server 1018 which stores the information.

A user at an individual PC (such as workstation 1012) that wishes to access the Internet typically does so using a software application known as a web browser. A web browser uses a standardized interface protocol, such as HyperText Transfer Protocol (HTTP), to make a connection via the Internet to other computers known as web servers, and to receive information from the web servers that is displayed on the user's display. Information displayed to the user is typically organized into pages that are constructed using a specialized language such as Hypertext Markup Language (HTML), Extensible Markup Language (XML), and Wireless Markup Language (WML), hereinafter (markup languages). Markup languages are typically based on the Standard Generalized Markup Language (SGML) that was created with the original purpose of having one standard language that could be used to share documents among all computers, regardless of hardware and operating system configurations. To this end, markup language files use a standard set of code tags embedded in their text that describes the elements of a document. The web browser interprets the code tags so that each computer having its own unique hardware and software capabilities is able to display the document while preserving the original format of the document.

Web pages are translated into the appropriate language and stored as hard-coded HTML and/or active server pages (ASP). There are a number of different web browsers available, each supporting their own extensions to markup languages such as HTML. Thus, a document written for one browser may not be interpreted as intended on another browser if it does not support the same extensions. XML was designed to meet the requirements of large-scale web content providers for industry-specific markup (i.e., encoded descriptions of a document's storage layout and logical structure), vendor-neutral data exchange, media-independent publishing, one-on-one marketing, workflow management in collaborative authoring environments.

By using XML, information providers can define new tag and attribute names at will, document structures can be nested to any level of complexity; and any XML document can contain an optional description of its grammar for use by applications that need to perform structural validation. However, the method is not limited to any software or mark-up language.

Each of the steps of the method disclosed may be performed by a module (e.g., a software module) or a portion of a module executing on a computer system. The method may be embodied in a machine-readable and/or computer-readable medium for configuring a computer system to execute the method. Thus, the software modules may be stored within and/or transmitted to a computer system memory to configure the computer system to perform the functions of the module.

Those of skill in the art will recognize that, based upon the teachings herein, several modifications may be made to the embodiments shown in FIGS. 1-10. For example, an electronic corporate network (intranet) can be used as a network for electronic communication between event 218 and 220 on FIG. 2.

While particular embodiments of the present invention have been shown and described, it will be recognized to those skilled in the art that, based upon the teachings herein, further changes and modifications may be made without departing from this invention and its broader aspects, and thus, the appended claims are to encompass within their scope all such changes and modifications as are within the true spirit and scope of this invention.

What is claimed is:

1. A method of ordering material, comprising:
considering the quantity of material available from a plurality of suppliers identifying a supplier to receive an order for material; and
sending electronically an order for material to the supplier identified to receive the order.

2. The method as recited in claim 1, wherein the material is not ordered until a manufacturer realizes a demand, wherein the manufacturer realizes the demand for the material after orders are received from customers, fulfilling the orders requiring assembling products, assembling the products requiring the material.

3. The method as recited in claim 1, wherein the order for material is sent electronically to a supplier logistics center, the supplier logistics center receiving material from a supplier.

4. The method as recited in claim 1, wherein the manufacturer takes title to the material after the material is shipped by the supplier.

5. The method as recited in claim 1, wherein the order requires delivery of the material within a specified period of time.

6. The method as recited in claim 5, wherein the specified period of time is less than one day.

7. A method of assembling a computer system, comprising:
considering the quantity of material available from a plurality of suppliers;
identifying a supplier to receive an order for materials;
ordering material from the supplier identified to receive the order; and
assembling the computer system at the assembly facility from material received at the assembly facility.

8. The method as recited in claim 7, wherein the material is ordered after a manufacturer realizes a demand, wherein the manufacturer realizes the demand for the material after orders are received from customers, fulfilling the orders requiring assembling products, assembling the products requiring the material ordered.

9. The method as recited in claim 7, wherein the material is ordered from a supplier logistic center, wherein the supplier logistics center receives material from a supplier.

10. The method as recited in claim 7, wherein the manufacturer takes ownership of the material after the material is shipped by the supplier.

11. The method as recited in claim 7, wherein the order specifies delivery of the material within a specified period of time.

12. The method as recited in claim 11, wherein the specified period of time is less than one day.

13. A method of manufacturing a computer system, comprising:
considering the quantity of material available from a plurality of suppliers identifying a supplier to receive an order for material;
sending electronically an order for material to the supplier identified to receive the order; and
manufacturing the computer system at a manufacturing facility using material received at the manufacturing facility.

14. The method as recited in claim 13, wherein the material is ordered after a demand is realized by the manufacturer, wherein the manufacturer realizes the demand for the material after orders are received from customers, fulfilling the orders requiring assembling products, assembling the products requiring the material.

15. The method as recited in claim 13, wherein the material is shipped from a supplier logistics center, wherein the supplier logistics center receives the material from a supplier.

16. The method as recited in claim 13, wherein the manufacturer takes title to the material after the material is shipped by the supplier.

17. The method as recited in claim 13, wherein the order requires delivery of the material within a specified period of time.

18. The method as recited in claim 15, wherein the specified period of time is 1 day.

19. A computer system, wherein the computer system is assembled by a method, the method comprising:
considering the quantity of material available from a plurality of suppliers identifying a supplier to receive an order for material;
sending electronically an order for material to the supplier identified to receive the order; and
assembling the computer at the assembly facility.

20. The computer system as recited in claim 19, wherein the material is shipped from a supplier logistics center, wherein the supplier logistics center receives the material from a supplier.

21. The method as recited in claim 19, wherein the manufacturer takes title to the material after the material is shipped by the supplier.

22. The computer system as recited in claim 19, wherein the order is sent electronically after a demand is realized by the manufacturer, wherein the manufacturer realizes the demand for the material after an order is received from a customer, fulfilling the order requiring assembling a products, assembling a products requiring the material.

23. The computer system as recited in claim 22, wherein the demand is realized by developing a schedule for a manufacturing facility, the order automatically generated by the schedule.

24. The computer system as recited in claim 23, wherein the order requires delivery of the material within a specified period of time.

25. The computer system as recited in claim 24, wherein the specified period of time is less than 1 day.
